(19) United States
(12) Patent Application Publication
(10) Pub. No.: US 2008/0283441 A1
(43) Pub. Date: Nov. 20, 2008

(54) Tray, Plano, Method and Device for Constructing

(75) Inventor: Bas Zetteler, Deventer (NL)

Correspondence Address: THE WEBB LAW FIRM, P.C., 700 KOPPERS BUILDING, 436 SEVENTH AVENUE, PITTSBURGH, PA, 15219, US

(73) Assignee: KAPPA ZEDEK B.V., Deventer (NL)

(21) Appl. No.: 11/884,588

(22) PCT Filed: Feb. 17, 2006
(86) PCT No.: PCT/NL2006/000083

§ 371 Date: Apr. 15, 2008

(30) Foreign Application Priority Data
Feb. 17, 2005 (NL) 1028312

(51) Int. Cl. B65D 1/34; B65D 5/00; B31B 1/26

(52) U.S. Cl. 206/557; 229/112; 493/162

(57) ABSTRACT

The invention relates to a serving tray, comprising a bottom wall and side edges, wherein the serving tray is manufactured from an integrally formed blank and wherein at least one side edge has a form suitable for placing in a holder with an array of support elements arranged one above the other, wherein the blank comprises cardboard. A preferred embodiment relates to such a serving tray, wherein at least two side edges are provided with carrier members for placing on the support elements of the holder.

The present invention relates to a serving tray, a blank therefor, a construction method and a device for the construction of a serving tray.

For serving food in transport means such as an aircraft, use is generally made of a small serving tray for serving a meal thereon to passengers during the flight. The crockery in which the meal is served, as well as cutlery and other products, fit on such a tray. For the transfer of a number of serving trays to the passenger use is made of a so-called trolley with an array of supports arranged one above the other for supporting these serving trays one above the other. The known serving trays used here are manufactured from plastics and are re-used. This re-use has the result that the serving trays have to be cleaned. For each flight a correct number of trays of the type desired for the flight must for instance be present, cleaned, in the food preparation kitchen.

In order to obviate such drawbacks the present invention provides a serving tray, comprising a bottom wall and side edges, wherein the serving tray is manufactured from an integrally formed blank and wherein at least one side edge has a form suitable for placing in a holder with an array of support elements arranged one above the other, wherein the blank comprises cardboard.

A serving tray according to the present invention has the advantage that it is suitable for once-only use, whereby cleaning for instance becomes unnecessary. The complex logistics for providing the food preparation kitchen to be used for a specific flight with the desired trays at the correct moment are also unnecessary. Used trays do not have to be transported back on a return flight. A topical print can further be applied, or an advertising print suitable for a period which is shorter than for instance the lifespan of a known serving tray.

In a first preferred embodiment according to the present invention at least two side edges are provided with carrier members for placing on the support elements of the holder. The application of such carrier members enables simple placing in a trolley of the serving tray according to the embodiment.

The carrier members are preferably formed by means of a folding profile of the blank. This enables a simple construction method for a profile of relatively complicated structure. A further advantage is that a blank of a serving tray can be taken in flat form to a position of use, such as a preparation space for meals at an airport.

In a further preferred embodiment the carrier members comprise a substantially horizontal underside and a connecting edge extending at an angle from the side edge to the horizontal side edge, the carrier members being formed by folded parts of the blank which extend in line with the side edge in the unfolded state. This arrangement of the components on the blank allows a construction method which is simple and can therefore be carried out quickly.

In such a serving tray according to the invention at least two side edges preferably extend at an angle from the bottom edge. A number of different embodiments hereby become possible, as will be described in greater detail below.

In one embodiment the side edges extend at an angle of 100-170 degrees relative to the bottom wall. It hereby becomes possible to stack the serving trays in nested manner, so that the use of space between the construction of the tray and use thereof and after use thereof is limited. This also results in a considerable reduction in the waste volume, this volume usually determining the cost of disposal of such waste.

Two carrier members are preferably situated at the top end of two of the side edges. The serving tray can be suspended on such carrier members from support elements in a trolley. The carrier members according to this embodiment can slide onto the support elements of the trolley as supports of a drawer, wherein the underside of the serving tray hangs downward between the support elements in the trolley.

A plurality of supports for the serving trays are placed relatively closely to each other in the trolleys to enable sliding-in of serving trays at a relatively large number of different positions. In one embodiment two side edges extend at an angle of 10-80 degrees relative to the bottom wall. It is hereby possible for a side which is higher than the mutual distance of two support elements of a trolley to extend sufficiently inward above the support elements on which it is placed at the position of the support elements, so that it fits between the higher support elements on both sides. A firm positioning of the serving tray is hereby also obtained. The serving tray herein supports on the underside of the side edge and a strip of the bottom wall adjacent hereto.

For the purpose of a relatively simple construction method for the serving tray, the areas for gluing are all situated in one embodiment on one side of the blank.

A further aspect of the present invention relates to a blank for a serving tray as specified in the foregoing.

A further aspect of the present invention relates to a construction method for constructing a serving tray according to one or more of the foregoing claims at a location of use by means of a construction device, comprising steps for:
providing the construction device,
introducing a blank into the device,
performing by the device of construction operations such as folding and/or gluing,
discharging constructed serving trays.

It is advantageous to manufacture the serving tray on location, since the blanks require less transport volume in flat state than the constructed serving trays.

A further aspect of the present invention relates to a construction device for constructing the serving tray at the location of use of a serving tray, comprising means for feeding through a blank, folding a blank along predetermined fold-lines and gluing a blank at predetermined gluing locations.

Further advantages, features and details of the present invention will be further described on the basis of several preferred embodiments, with reference to the accompanying figures, in which:

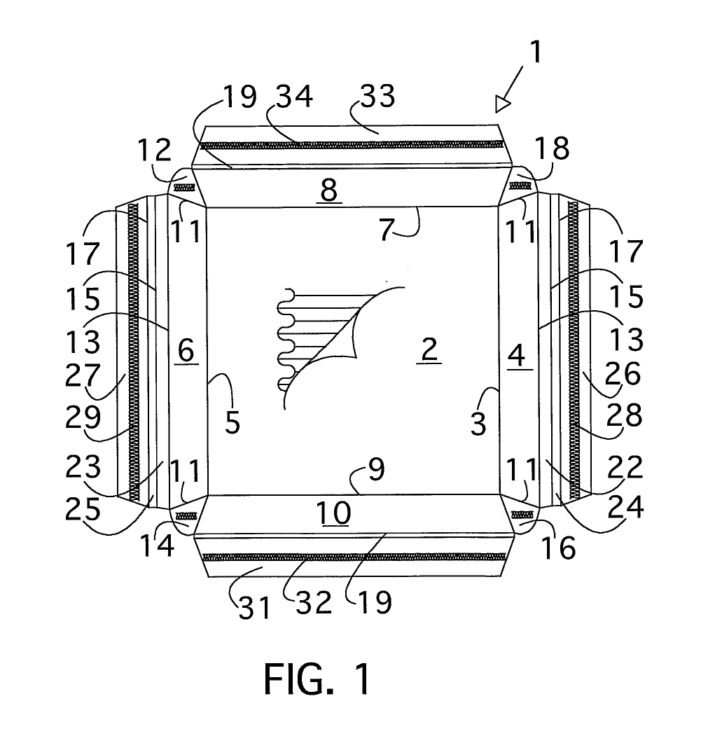

FIG. 1 is a view of a blank in flat form according to a first embodiment according to the present invention;

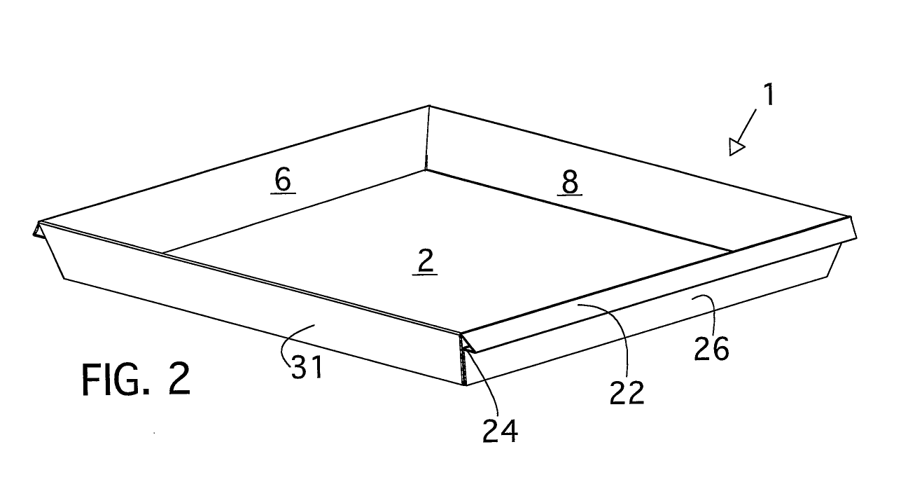

FIG. 2 is a perspective view of the embodiment of FIG. 1 in constructed state;

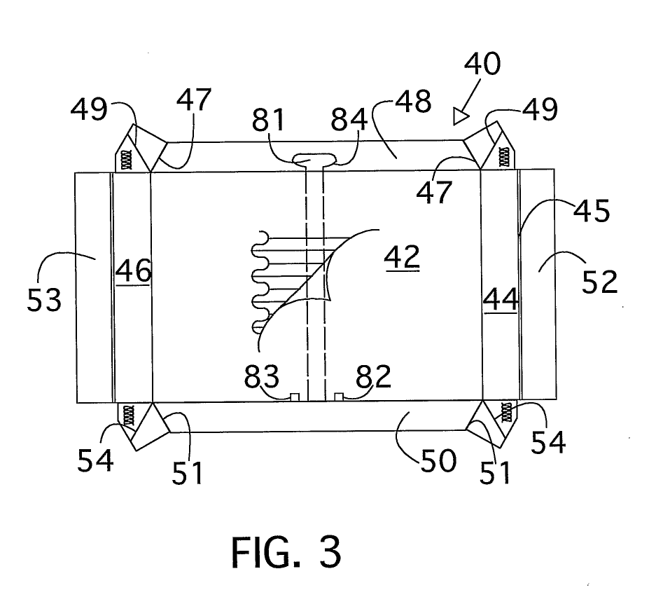

FIG. 3 is a view of a blank in flat form according to a second embodiment according to the present invention;

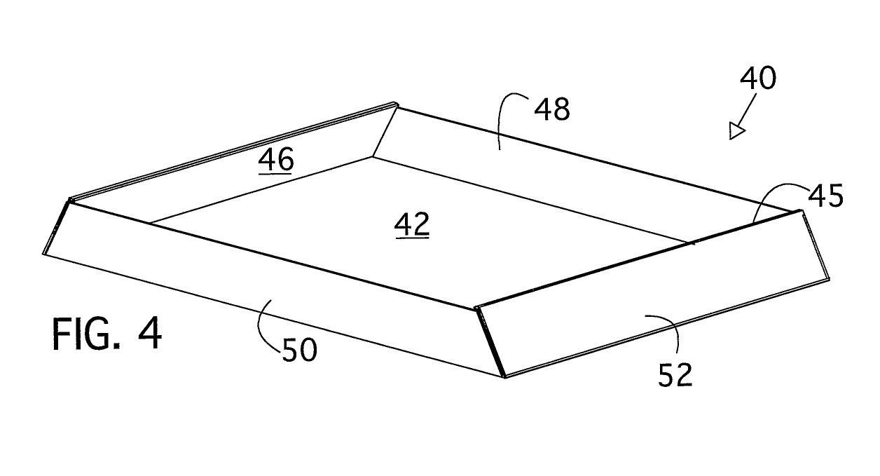

FIG. 4 is a perspective view of the embodiment of FIG. 3 in constructed state;

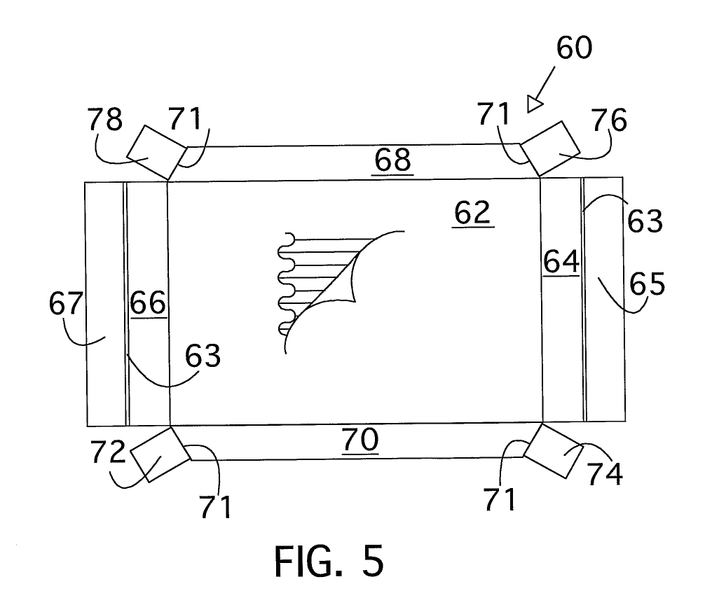

FIG. 5 is a view of a blank in flat form according to a third embodiment according to the present invention;

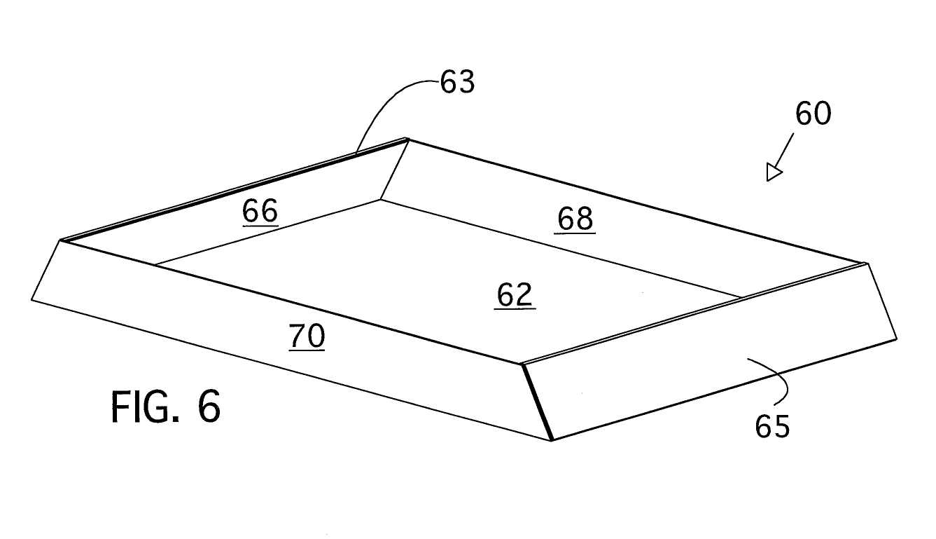

FIG. 6 is a perspective view of the embodiment of FIG. 5 in constructed state;

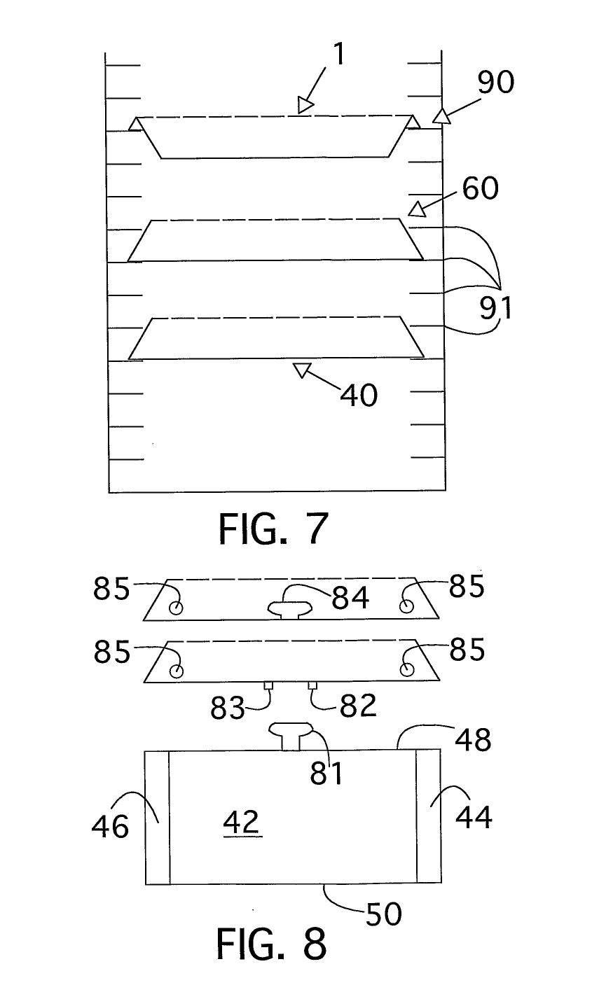

FIG. 7 is a schematic representation of a trolley with the embodiment of the foregoing figures placed therein;

FIG. 8 is a schematic representation, a top view and a side view of an embodiment provided with releasable fastening means.

A first embodiment according to the present invention (FIG. 1) relates to a blank in flat form 1 which is built up around a base board 2. On the top side is situated a strip 8 having strip 33 thereon. Situated in corresponding manner on the bottom side is strip 10 having strip 31 thereon. These strips serve to form two edges of the serving tray. For this purpose strip 33 is provided with a glue strip 34 on the rear side. Strip 33 is folded downward against strip 8 along fold-line 19. In the construction of the serving tray, strip 31 is folded downward in similar manner against strip 10 along fold-line 19. This downward folding of strips 31 and 33 takes place during the construction of the serving tray after tabs 12,14, 16,18 have been adhered to the rear side of strips 8,10.

On the left and right-hand side of base board 2 are situated strips 4,6 which form the inner side of two edges of the serving tray. Tabs 12,14 are attached to strip 6. These tabs serve for the purpose of fastening strip 6 to strips 8,10. Strips 23,25,27 are situated successively on strip 6. Strips 23,25 serve to form a carrier member, wherein strip 27 serves as fastening means on the rear side of strip 6. For this purpose strip 27 is provided on the rear side thereof with a glue strip 29.

During the construction of the serving tray the strip 6 is folded upward along fold-line 5, strip 23 is folded downward along fold-line 13, strip 25 is folded downward along fold-line 15, and strip 27 is folded upward along fold-line 17. Glue strip 29 is then pressed onto the rear side of strip 6.

Tabs 16,18 are attached to strip 4. These tabs serve to fasten strip 4 to strips 8,10. Strips 22,24,26 are situated successively on strip 8. Strips 22,24 serve to form a carrier member, wherein strip 26 serves as fastening means on the rear side of strip 4. For this purpose strip 26 is provided on the rear side thereof with a glue strip 28.

During the construction of the serving tray strip 6 is folded upward along fold-line 3, strip 22 is folded downward along fold-line 13, strip 24 is folded downward along fold-line 15, and strip 26 is folded upward along fold-line 17. Glue strip 28 is then pressed onto the rear side of strip 4. Following these operations, strips 33 and 31 are finally adhered by means of pressing respective glue strips 34 and 32 onto the rear side of the respective strips 8 and 10.

The serving tray shown in perspective in FIG. 2 is hereby obtained. Edges 4,6, 8,10 extend obliquely outward so that the serving trays can be stacked in nestable manner. In stacked situation the carrier members of serving trays situated on top of each other will support on each other. The serving trays hereby take up relatively little space, even in the constructed state. A further advantage is that all the sides of the serving tray which are visible during use are situated on one side in blank form, whereby all these visible parts can be provided in simple and advantageous manner with a printed surface in one print run. If the tray is for once-only use, such a printed surface can be adapted to the situation in which such a tray is used. This can be a different print per airline or rail company, but can also be changed frequently over time.

A second preferred embodiment relates to a serving tray which can be folded from a blank 40, which is shown in flat form in FIG. 3. The serving tray is built up around base board 42. On either side are situated strips 44,46 with strips 52,53 connected thereto by means of fold-lines 45. These strips serve to form double side edges of the serving tray, which side edges protrude toward each other from base board 42 in the assembled state of the serving tray. On the top and bottom side of the blank are situated side edge strips 48,50. These strips serve to forming the two remaining side edges.

Situated between strips 44,46,48,50 are corner pieces with fold-lines 47,49,51,53,54. After cutting the blanks, glue strips 55 are arranged on the corner pieces. Strips 48 and 50 are then folded along fold-lines 56 so that adhesive strips 55 are pressed against strips 44 and 46. The semi-products glued in this manner can then be transported flat in this once-folded state to a location of use and stored in a manner which takes up relatively little space.

The serving tray can then be produced by folding strips 44 and 46 upward along fold-lines 57 and then folding strips 52 and 53 inward, so that due to this combination of movements the edges stand up, edges 48,50 move into vertical position, and edges 44,52 and 46,53 move into oblique position as shown in FIG. 4. As shown in FIG. 7, the wide bottom side supports on support members 91 of a trolley, while the narrower top side fits between the sub-sequent support members 91.

In this embodiment protrusions 82,83 are also cut out during cutting of the blank, and hook member 81 is cut out along score line 84. As shown in FIG. 8, in the position of use this hook member can protrude and hook between protrusions 82,83 shown in side view in FIG. 8. Hooking of the hook member between the protrusions is practical when two or more serving trays are placed one behind the other in a trolley when this trolley is given a deep form. In this case the rear tray can be pulled along with a preceding one, and the rear tray can be removed more easily from the trolley.

An alternative to this hook with protrusions is the application of magnetic paint spots 85 on the side walls of the serving tray. The rear tray is pulled along by means of magnetic force by a tray lying in front of it in a trolley. The magnetic connection can be broken in simple manner by a bending or pivoting movement of the front tray.

An alternative to the second embodiment is shown in FIGS. 5 and 6. This blank 60 likewise comprises a bottom wall 62 and four side edges 64,66,68,70. Edges 64 and 66 are connected to folding strips 65, 67 respectively by means of fold-lines 63. Flaps 72,74,76,78 are connected to either side of edge strips 68,70 by means of fold-lines 71. This serving tray is built up by means of first folding side edges 68,70 upward into a substantially vertical position. Flaps 72,74,76,78 are then folded slightly inward, whereafter strips 64,66 are folded upward and strips 65,67 are folded round the flaps. The final result is visually similar to the second embodiment, and shown in FIG. 6. Side edges 68,70 are substantially vertical and the two other side edges are oriented obliquely inward. The advantages hereof have already been stated with reference to the second embodiment. The assembly can be carried out by hand in simple manner.

Trolleys which are used and for which the tray is suitable are for instance an Atlas, KSSU service trolley. The glue used in the construction of the trays according to the present invention can be hot melt which is applied during the construction, but can also be glue which is applied during the manufacture of the blank and which remains covered until the construction.

The present invention is described on the basis of preferred embodiments to which the invention is not limited. Diverse aspects of the embodiments can be freely combined with each other. The rights sought are defined by the appended claims.

1: Serving tray, comprising a bottom wall and side edges, wherein the serving tray is manufactured from an integrally formed blank and wherein at least one side edge has a form suitable for placing in a holder with an array of support elements arranged one above the other, wherein the blank comprises cardboard.

2: Serving tray as claimed in claim 1, wherein at least two side edges are provided with carrier members for placing on the support elements of the holder.

3: Serving tray as claimed in claim 2, wherein the carrier members are formed by means of a folding profile of the blank.

4: Serving tray as claimed in claim 2, wherein the carrier members comprise a substantially horizontal underside and a connecting edge extending at an angle from the side edge to the horizontal side edge, the carrier members being formed by folded parts of the blank which extend in line with the side edge in the unfolded state.

5: Serving tray as claimed in claim 1, wherein at least two side edges extend at an angle from the bottom edge.

6: Serving tray as claimed in claim 3, wherein four side edges extend at an angle of 100-170 degrees relative to the bottom wall.

7: Serving tray as claimed in claim 3, wherein two carrier members are situated at the top end of two of the side edges.

8: Serving tray as claimed in claim 3, wherein at least two side edges extend at an angle of 10-80 degrees relative to the bottom wall.

9: Serving tray as claimed in claim 3, wherein the underside of the side edge with a strip of the bottom wall adjacent thereto serves as carrier member.

10: Serving tray as claimed in claim 1, wherein the areas for gluing are all situated on one side of the blank.

11: Serving tray as claimed in claim 1, wherein it is provided with a moisture-repellent coating.

12: Serving tray as claimed in claim 1, comprising releasable fastening means for fastening two or more serving trays one behind the other.

13: Serving tray as claimed in claim 1 for use with trolleys in transport means such as aircraft and trains.

14: Blank for a serving tray as claimed in claim 1.

15: Construction method for constructing a serving tray as claimed in claim 1 at a location of use by means of a construction device, comprising:
providing the construction device,
introducing a blank into the device,
performing by the device of construction operations such as folding and/or gluing, and
discharging constructed serving trays.

16: Method as claimed in claim 15, comprising steps for folding flaps of the blank along predetermined fold-lines.

17: Construction device for performing a method as claimed in claim 15 at the location of use of a serving tray, comprising means for feeding through a blank, folding a blank along predetermined fold-lines and gluing a blank at predetermined gluing locations.

18: Serving tray as claimed in claim 3, wherein the carrier members comprise a substantially horizontal underside and a connecting edge extending at an angle from the side edge to the horizontal side edge, the carrier members being formed by folded parts of the blank which extend in line with the side edge in the unfolded state.

19: Serving tray as claimed in claim 2, wherein at least two side edges extend at an angle from the bottom edge.

20: Construction device for performing a method as claimed in claim 16 at the location of use of a serving tray, comprising means for feeding through a blank, folding a blank along predetermined fold-lines and gluing a blank at predetermined gluing locations.
